(19) United States
(12) Patent Application Publication
(10) Pub. No.: US 2024/0343472 A1
(43) Pub. Date: Oct. 17, 2024

(54) Single Serve Capsule for Preparing a Beverage with the Aid of a Beverage Preparation Machine, and Use of a Single Serve Capsule

(71) Applicant: K-FEE SYSTEM GMBH, Bergisch Gladbach (DE)

(72) Inventors: Marc Krüger, Bergisch Gladbach (DE); Günter Empl, Bergisch Gladbach (DE)

(21) Appl. No.: 18/580,306

(22) PCT Filed: Aug. 1, 2022
(86) PCT No.: PCT/EP2022/071508

§ 371 Date: Jan. 18, 2024

Related U.S. Application Data
(60) Provisional application No. 63/227,708, filed on Jul. 30, 2021.

(30) Foreign Application Priority Data
Aug. 12, 2021 (DE) 10 2021 208 857.0

(51) Int. Cl. B65D 85/804; A47J 31/44

(52) U.S. Cl. CPC B65D 85/8058; A47J 31/4492

(57) ABSTRACT

A single serve capsule for preparing a beverage with aid of a beverage preparation machine, the single serve capsule having a base element with a cavity for receiving a beverage raw material, and a capsule lid which closes the cavity; the base element including a capsule base, an encircling flange and a capsule wall which extends from the capsule base to the encircling flange; the capsule lid being fastened to the encircling flange; the single serve capsule having an optically detectable feature which is optically detectable by a detector of the beverage preparation machine and which is disposed on a side of the encircling flange facing away from the capsule lid, the single serve capsule has a further base element which at least partially surrounds the base element.

### Cross Reference To Related Applications

This application is a US National Stage of PCT/EP2022/071508 filed Aug. 1, 2022, which claims priority to U.S. 63/227,708 filed Jul. 30, 2021 and to DE 10 2021 208 857.0 filed Aug. 12, 2021, all of which are hereby incorporated by reference herein for all purposes.

### FIELD

The present invention proceeds from a single serve capsule for preparing a beverage with the aid of a beverage preparation machine, the single serve capsule having a base element with a cavity for receiving a beverage raw material, and a capsule lid which closes the cavity; the base element comprising a capsule base, an encircling flange, and a capsule wall which extends from the capsule base to the encircling flange; the capsule lid being fastened to the flange; the single serve capsule having in particular a feature which is optically detectable by a detector of the beverage preparation machine.

### BACKGROUND

Such single serve capsules are known from the prior art. For example, publication WO 2016/186 488 A1 discloses such a generic single serve capsule. This single serve capsule is provided to be placed in a brewing chamber in which the single serve capsule is perforated so as to direct brewing liquid in the form of pressurized hot water into the cavity. A beverage is created as a result of the interaction between the introduced water and the beverage raw material, in particular roasted and ground coffee, the beverage exiting the single serve capsule by way of further perforated locations and making its way into a vessel.

For each single serve capsule there is typically a matching beverage preparation machine which is optimized for preparing beverages based on the matching single serve capsule. For the avoidance of malfunctions, it has proven successful to provide single serve capsules of this type with detectable features that are optically readable by a machine in such a way that a verification as to whether the inserted single serve capsule is compatible with the machine can take place prior to the beginning of the brewing process. Optionally, a matching brewing program for the beverage raw material located in the single serve capsule can moreover be started.

From publications EP 3 023 362 B1, WO 2020/201 487 A1 and U.S. Pat. No. 10,800,600 B2 it is known to print such optically detectable features in the form of bar codes or binary codes onto the flange of the capsule.

### SUMMARY

It is an object of the present invention to make available a single serve capsule having an optically detectable feature (hereunder also referred to only as feature) of the type mentioned at the outset, which represents an improvement in comparison to the solutions known from the cited prior art. It is the intention in particular that the reliability in terms of reading the detectable feature by the detector of the beverage preparation machine is increased, and the sensitivity of the detectable feature in relation to damage (scratching) due to external forces acting thereon during transport or storage of the single serve capsules is reduced. It is furthermore an objective to lower the production costs, the production time and/or the weight of the single serve capsule.

The object of the present invention is achieved by a single serve capsule as disclosed herein.

Advantageous design embodiments and refinements of the invention can be derived from the disclosure herein and the following description with reference to the drawings.

Disclosed is a single serve capsule according to the invention, for preparing a beverage with the aid of a beverage preparation machine, the single serve capsule having a base element with a cavity for receiving a beverage raw material, and a capsule lid which closes the cavity; the base element comprising a capsule base, an encircling flange and a capsule wall which extends from the capsule base to the encircling flange; the capsule lid being fastened to the flange; the single serve capsule having a feature which is optically detectable in particular by a detector of the beverage preparation machine and which is disposed on a side of the flange facing away from the capsule lid, wherein the single serve capsule has a further base element (12′) which at least partially surrounds the base element. The further base element (also referred to as the outer base element) can advantageously be configured as a shape-imparting or structure-imparting base part, while the base element (also referred to as the inner base element), which has the flange with the optically detectable feature, can be optimized with a view to a favorable production method. As a result, the optically detectable feature can be imprinted or implemented in a particularly cost-effective manner in this way. For example, the inner base element can be configured to be substantially less dimensionally stable (at least in the region of the capsule wall or of the capsule base) than the outer base element, or can optionally be optimized with a view to an additional function such as the tightness in terms of flavor, for example. Owing to the fact that the capsule walls overlap, it is possible for the two base elements to be easily assembled and fastened to one another. The explanations hereunder pertaining to preferred refinements of this single serve capsule optionally also apply to all other single serve capsules disclosed in this description.

It is preferably provided that the further base element (12′) has a further cavity (20′) in which the base element is partially disposed.

It is preferably provided that the base element is disposed so far within the further cavity (20′) that a further capsule wall (14′) of the further base element (12′) extends, in particular parallel to the capsule wall of the base element, to the flange.

It is preferably provided that the further base element (12′) is configured to be free of a flange.

It is preferably provided that the material in the region of the capsule wall of the base element is configured to be softer, less stiff, or thinner than in the region of the capsule wall (14′) of the further base element (12′).

It is preferably provided that the material of the base element is configured to be more impermeable to gas than the material of the further base element (12′).

It is preferably provided that the base element and the further base element (12′) are adhesively bonded or welded to one another in a planar manner in the region of the capsule walls.

It is preferably provided that the base element and the further base element (12′) are made of the same material or of different materials.

It is preferably provided that the optically detectable feature is a machine-readable code, preferably a one-dimensional or multi-dimensional bit code or bar code.

A further subject matter of the present invention is the use of the abovementioned single serve capsule according to the invention for preparing a beverage with the aid of a beverage preparation machine.

It goes without saying that the above explanations pertaining to various single serve capsules are also to be understood in combination with one another.

According to a preferred embodiment of the present invention it is provided that the base element is made integrally of aluminum and/or plastics material. The base element is preferably produced by cold or hot forming, in particular deep drawing. The design embodiment of the base element with a cavity is preferably generated by thermoforming, for example deep drawing by means of negative pressure, positive pressure and/or a movable ram. The base element is preferably configured as a deep-drawn aluminum part. Alternatively, it would however also be conceivable that the base element is configured from polyethylene (PE), polypropylene (PP), polyvinylchloride (PVC) or polyethylene terephthalate (PET). Alternatively, the single serve capsule is produced by means of injection molding methods, in particular by the single-component, multi-component or in-mold method.

The base element is preferably of a frustoconical, conical, cylindrical, spherical, hemispherical, elliptic, or partially elliptic configuration. The base element is preferably of a rigid or semi-rigid configuration. The cavity formed by the base element serves for receiving beverage raw material, for example roasted coffee granules, instant coffee, chocolate powder, tea blends, milk powder and/or the like. The lid film is in particular of a planer or almost planar configuration, at least immediately after closing the filled single serve capsule with the lid film. Any crownings of the lid film over time by gas emissions of coffee powder do not preclude the lid film being planar in the context of the present invention because these crownings typically occur only at some time after filling the single serve capsule.

The lid film preferably comprises an aluminum foil or a plastic/aluminum composite film, or a plastic film, or a multi-layer plastic film. It is conceivable that the single serve capsule is configured to be rotationally symmetrical about its longitudinal axis. The longitudinal axis thus forms a central axis of rotational symmetry which runs centrically through the single serve capsule and therefore, in particular, substantially perpendicularly to a plane of main extent of the lid film. The flange of the base element preferably runs at an angle between 70 and 110 degrees, particularly preferably from 80 to 100 degrees, and most particularly preferably of substantially 90 degrees, in relation to the axis of rotational symmetry. The flange is configured to be encircling, in particular closed in an encircling manner. The free outer end of the flange preferably has a bead, a flanging, or a so-called crimped rim, so as to avoid injury to the user on the sharp-edged end.

The single serve capsule can contain one or a plurality of beverage substances. The one or the plurality of beverage substances may be a liquid, a sirup, a solid, a powder, coffee or cocoa grounds, tea leaves, or a combination thereof. The one or the plurality of beverage substances can be diluted or extracted in a beverage preparation machine and/or a beverage system in order to prepare a beverage.

The single serve capsule can comprise each of the optically detectable features and/or elements described and/or depicted herein. Each of the features and/or elements described herein can be combined for producing a single serve capsule. Each of the features and/or elements described herein can be duplicated in order to produce a single serve capsule. Each of the features and/or elements described herein can be eliminated or omitted in order to produce a single serve capsule. Each of the features disclosed herein can be rearranged on each of the elements or surfaces listed herein. For example, a feature or element which is said to be located on the flange of the single serve capsule may additionally or alternatively be disposed on the lid or the base element.

The single serve capsule can have a body or a base element. The body or the base element can be a container, or form one or a plurality of cavities in which the beverage substance and/or one or a plurality of elements are received and/or stored. The body or the base element can have a lateral wall with radiused, curved or hemispherical surfaces. The body or the base element can have a lateral wall with rectilinear, flat or tapered faces. The body or the base element can have a lateral wall with surfaces that form a hemisphere, a dome, a cone, or a truncated cone. The base element can have a base area. The base area can be radiused or be hemispherical. The base area can be generally flat or planar. The base area can have one or a plurality of concavities. If the base has more than one depression, the two or more depressions can be concentric or lie in one another. The base area can be angled or inclined in relation to the lateral wall.

The single serve capsule can have a flange. The flange and the base element can be composed of one or a plurality of integral materials. The flange and the base element can be formed from one or a plurality of separate materials and then be connected to one another by a joining process. For example, the flange and the base element can be connected using an adhesive, a seal, or any other suitable connecting method. The flange can be composed of the same material as the base element and/or the lid. The flange can be composed of a different material than the base element and/or the lid. The flange can have an annular shape which extends at least partially about the entire circumference of the base element. In specific embodiments, the flange can however extend only about part of the circumference of the base element. In some cases, the flange can be composed of two or more tabs which extend from the base element. The flange can extend or project outward from the base element or the lateral wall of the base element. The flange can extend at an angle from the base element in such a way that an angle between the upper face of the flange and the lateral wall of the capsule is an acute angle (of less than 90 degrees). The flange can extend at an angle from the base element in such a way that an angle between the upper side of the flange and the lateral wall of the capsule is an obtuse angle (of less than 90 degrees). The flange can extend at an angle from the base element in such a way that an angle between the upper side of the flange and the lateral wall of the capsule is approximately a right angle (of approximately 90 degrees).

The flange can be located on the upper side of the base element. The flange can be located on the lower side of the base element. The flange can be located in a region between the lower surface and the lower surface of the base element. The flange can be located closer to the upper side than the lower side of the base element, or vice versa.

The single serve capsule can be provided with a lid (also referred to as the capsule lid). The lid can close or seal the cavity or the base element once the beverage ingredient has been added or incorporated in the cavity. The lid can generate an air-tight or hermetic seal so as to maintain the freshness of the beverage ingredient. The lid can cause a seal that is not air-tight or hermetic. The lid can generate a seal in such a way that air and moisture can be prevented from invading the cavity or the capsule, and/or from leaving the latter. The lid can be fastened to the single serve capsule, to the base element, to the upper side of the base element, to the lower side of the base element, to the flange, to the upper side of the flange, to the lower side of the flange, or to a combination thereof. The lid can be attached by adhesive bonding, welding, or any other suitable fastening method or device. The lid can be composed of the same material as the base element and/or the flange. The lid can be produced from a different material than the base element and/or the flange. The lid, the flange and/or the base element can be composed of one or a plurality of integral materials. The lid, the flange and/or the base element can be composed of one or a plurality of separate materials and then be connected to one another by a joining process. For example, the lid, the flange and/or the base element can be connected using an adhesive, a seal, a welding method, or any other suitable connecting method.

The single serve capsule, the body or the base element, the flange and/or the lid can be composed of a material which is suitable for preparing a beverage and/or for storing ingredients for the beverage preparation. The single serve capsule, the base element, the flange and/or the lid can be produced from a metal. The single serve capsule, the base element, the flange and/or the lid can be composed of a non-metallic material. The single serve capsule, the base element, the flange and/or the lid can be produced from a recycled material. The single serve capsule, the base element, the flange and/or the lid can be produced from a recyclable material. The single serve capsule, the base element, the flange and/or the lid can be produced from a biologically decomposable material. The single serve capsule, the base element, the flange and/or the lid can be produced from a paper material. The single serve capsule, the base element, the flange and/or the lid can be produced from a compostable material. The single serve capsule, the base element, the flange and/or the lid can be produced from a cellulosic material. The singe serve capsule, the base element, the flange and/or the lid can be produced from a material containing polylactic acid. The single serve capsule, the base element, the flange and/or the lid can be produced from a material which is more or less resistant to deformation, decomposition and collapsing at temperatures of up to at least 120° C. The single serve capsule, the base element, the flange and/or the lid can be produced from a material harvested from corn. The single serve capsule, the base element, the flange and/or the lid can be produced from a plant-based material. The single serve capsule, the base element, the flange and/or the lid can be produced from a material which is free of polystyrene. The single serve capsule, the base element, the flange and/or the lid can be produced from a food-safe material. The single serve capsule, the base element, the flange and/or the lid can be produced by injection-molding, thermoforming, drawing, or the like. The base element, the flange and/or the lid can be laminated. The single serve capsule, the base element, the flange and/or the lid can be produced from an electrically conductive material. The single serve capsule, the base element, the flange and/or the lid can be produced from an electrically non-conducting material. The single serve capsule, the base element, the flange and/or the lid can be produced from a woven fabric material. The single serve capsule, the base element, the flange and/or the lid can be produced from a rubber material. The single serve capsule, the base element, the flange and/or the lid can be produced from a plastics material. The single serve capsule, the base element, the flange and/or the lid can be produced from aluminum. The single serve capsule, the base element, the flange and/or the lid can be composed of a material that is elastic or deformable. The base element, the flange and/or the lid can be composed of a deformable material which can withstand various liquid temperatures (hot and cold) and pressures without being damaged (i.e. without the base element, the flange and/or the lid rupturing or breaking in undesirable regions). The single serve capsule, the base element, the flange and/or the lid can have generally identical wall thicknesses. The single serve capsule, the base element, the flange and/or the lid can have different wall thicknesses. For example, the single serve capsule, the base element, the flange and/or the lid can have a thicker wall thickness in specific regions so as to prevent destruction of the single serve capsule during handling and/or use.

The single serve capsule can have one or a plurality of capsule features. The one or the plurality of capsule features can be one or a plurality of protrusions, ridges, elevations and/or convexities which extend away from the external face of the base element, or protrude beyond the latter. The one capsule feature, or the capsule features, can be one or a plurality of channels, grooves, depressions, troughs or concavities which extend from the external face into the base element, or project into the latter. The one capsule feature, or the capsule features, can extend about the entire circumference of the body or of the base element. The one capsule feature, or the plurality of capsule features, can also extend only about part, or a region, of the circumference of the body or of the base element. The one surface capsule feature, or the plurality of surface capsule features, can extend continuously about the body or the base element. The one capsule feature, or the plurality of capsule features, can extend in an intermittent manner (beginning and end) about the body or the base element. The one capsule feature, or the plurality of capsule features, can be located only on the base element. The one capsule feature, or the plurality of capsule features, can be located only on the lid. The one capsule feature, or the plurality of capsule features, can be disposed only on the flange. The one capsule feature, or the plurality of capsule features, may not be located on the bode, the flange, the lid, or a combination thereof. The one capsule feature, or the plurality of capsule features, can be located on the internal face of the base element. The one capsule feature, or the plurality of capsule features, can be disposed on the external face of the base element. The one capsule feature, or the plurality of capsule features, can be disposed on the upper side of the flange, the lower side of the flange, the lateral face of the flange, or a combination thereof. The one capsule feature, or the plurality of capsule features, can be one or a plurality of rings which extend about the entire circumference, or part of the circumference, of the single serve capsule. The one or the plurality of features of the single serve capsule can be diagonal, or extend along a diagonal or at an angle relative to a central longitudinal axis of the single serve capsule. The one capsule feature, or the plurality of capsule features, can have irregular shapes such as scrolls and twirls. The one capsule feature, or the plurality of capsule features, can be vertically aligned (from the upper side to the lower side of the base element). The one capsule feature, or the plurality of capsule features, can extend on the flange (upper side, lower side and/or lateral face of the flange). The one capsule feature, or the plurality of capsule features, may not extend on the flange. The one capsule feature, or the plurality of capsule features, can extend from the flange to the base area of the base element. The one capsule feature, or the plurality of capsule features, can extend from the flange in the direction of the base area of the base element, but must not extend to the base area. The one capsule feature, or the plurality of capsule features, can extend from the lower surface of the base element to the upper surface of the base element, but must not extend to the upper surface. The spacing between the adjacent capsule features can be uniform. In other words, the spacing between some or all capsule features can be substantially identical. The spacing between adjacent capsule features can be dissimilar. In other words, the spacing between some or all capsule features can be dissimilar. The one capsule feature, or the plurality of capsule features, can have a zebra shape, or a printed zebra pattern. This can mean that the one capsule feature, or the plurality of capsule features, extend along at least part of the (or the entire) body or base element, lid and/or flange. The one capsule feature, or the plurality of capsule features, can fade or be less visible in specific regions, while they are more intense or better visible in other regions. For example, the visibility of the one capsule feature, or of the plurality of capsule features, can vary. For example, the depth of a depression or groove may become flatter or deeper in specific regions of the base element, of the lid and/or of the flange. For example, the height or the protrusion of a rib or of a ridge may be larger or smaller in specific regions of the base element, of the flange and/or of the lid than in other regions of the base element, of the flange and/or of the lid.

The one capsule feature, or the plurality of capsule features, can be located only on the external face of the lateral wall or of the body. The one capsule feature, or the plurality of capsule features, can be located only on the internal face of the lateral wall or of the body. The one capsule feature, or the plurality of capsule features, can be located on the internal face as well as on the external face of the lateral wall or of the body. The one capsule feature, or the plurality of capsule features, located on the external surface, can correspond to the one capsule feature, or the plurality of capsule features, located on the internal face of the capsule body. For example, a groove on the external face of the capsule body can form a rib or a protrusion on the internal face of the lateral wall, or vice versa. For example, a groove on the upper side of the flange or lid can form a rib or a protrusion on the lower side of the flange or lid, or vice versa.

The one capsule feature, or the plurality of capsule features, located on an internal face or in the interior of the cavity can serve for varying or interrupting the liquid stream of the beverage into and/or through the base element. The one capsule feature, or the plurality of capsule features, can serve to cause or generate a turbulent liquid stream into and/or through the capsule. The one capsule feature, or the plurality of capsule features, can serve to cause or generate a laminar liquid stream into and/or through the capsule. The one capsule feature, or the plurality of capsule features, can serve to cause the liquid to swirl into and/or through the capsule. The one capsule feature, or the plurality of capsule features, can cause the liquid flowing in and through the capsule to move upward and/or downward so as the extract and/or dissolve the beverage component in the capsule.

The single serve capsule can be coated with an ink, with a material that imparts a metallic appearance to the single serve capsule and can be produced from an ink or metallic flakes or metallic particles or pigments. The particles can be suspended or dispersed in an aqueous medium and then be applied to the base element, the lid and/or the flange. In order to provide the metallic appearance, it is possible that the particles or pigments are incorporated in the plastics material when the plastics material is in a fused or softened state. For example, an aluminum flake material can be added to the plastics material so as to impart the latter a unique appearance, and/or to hide production swirls or defects which as a result of

The one capsule feature, or the plurality of capsule features, can be configured integrally on the capsule body or the base, the lid and/or the flange. The one capsule feature, or the plurality of capsule features, can be added to the capsule body or the base, the lid and/or the flange. The one capsule feature, or the plurality of capsule features, can be printed on or attached to the capsule body or the base, the lid and/or the flange. The one capsule feature, or the plurality of capsule features, can be molded or produced from the same material as the capsule body, the flange and/or the lid. The one capsule feature, or the plurality of capsule features, can be molded or produced from a different material than the capsule body, the flange and/or the lid. The one capsule feature, or the plurality of capsule features, can be printed, embossed, etched, adhesively bonded or attached on or to the capsule body, the flange and/or the lid.

The one capsule feature, or the plurality of capsule features, can be adhesively bonded or welded to the capsule base, or fastened to the latter in another way.

The one capsule feature, or the plurality of capsule features, can also be the one or the plurality of optically identifiable features. In this context, the one capsule feature, or the plurality of capsule features, can serve for one or a plurality of purposes or functions disclosed herein. Alternatively, the one capsule feature, or the plurality of capsule features, can fulfil only the function or the purpose of an optically identifiable feature.

The single serve capsule can have one or a plurality of optically identifiable features. The one optically identifiable feature, or the plurality of optically identifiable features, can be located on the singe serve capsule, the body or the base element, the lateral wall, the external face of the lateral wall, the internal face of the lateral wall, the flange, the upper side of the flange, the lower side of the flange, the lateral face of the flange, the lid, the upper side of the lid, the lower side of the lid, the lateral face of the lid, or a combination thereof.

The one optically detectable feature, or the plurality of optically detectable features, can be read, detected, recognized and/or identified by one or a plurality of detectors of the beverage machine and/or of the system. The one detector, or the plurality of detectors, can be one or a plurality of lasers, lights, light curtains, scanners, readers, eyes, cameras, bar code readers, bit code readers, or a combination thereof. Once the single serve capsule has been introduced into the beverage machine, the one or the plurality of detectors can be disposed above the single serve capsule, below the single serve capsule, beside the single serve capsule, or a combination thereof. The one detector, or the plurality of detectors, can contain one or a plurality of processors, memories, programs, hard drives, RAMs, or other computer hardware and software, or be electronically connected thereto. The one detector, or the plurality of detectors, can function in such a way that they read or identify the one or the plurality of optically identifiable features, and/or correlate the latter with one or a plurality of stored references. One of the read optically identifiable feature, or a plurality of the read optically identifiable features, can be stored on a hard drive, in a memory, or in a cloud of the detector, of the beverage machine, or in both. The one detector, or the plurality of detectors, can function in such a way that they read or identify the one or the plurality of optically identifiable features, and/or correlate the latter with one or a plurality of stored references so as to determine the type of single serve capsule. For example, the one detector, or the plurality of detectors, can recognize whether the single serve capsule contains coffee, expresso, cocoa, alcoholic or non-alcoholic beverage ingredients, or ingredients for cleaning the machine. For example, the one detector, or the plurality of detectors, can recognize whether the single serve capsule requires warm, cold or ambient water, or any other liquid (milk, juice, etc.), in order to prepare the desired beverage. For example, the detector or detectors can ascertain the machine parameters for preparing the desired or intended beverage, such as, for example, the liquid temperature, the liquid pressure, the liquid quantity, the heating or cooling time and/or temperature, whether additional ingredients or liquids have to be mixed with the beverage, or whether said additional ingredients or liquids have to run through the single serve capsule. The one detector, or the plurality of detectors, can be capable of identifying the machine parameters for cleaning the beverage machine when the detector recognizes that the capsule is specified for cleaning the machine. The one detector, or the plurality of detectors, can function in such a way that they recognize an incompatible optically detectable feature when a single serve capsule that is not intended for use in the machine is introduced into the machine. This can advantageously prevent errors from occurring, the machine being damaged, and/or an operator or bystander being injured.

The one optically identifiable feature, or the plurality of optically identifiable features, can be one or more of the following: colors, patterns, logos, bar codes (two-dimensional and/or three-dimensional), bit codes, binary codes, depressions, notches, elevations, protrusions, elevations. The one optically identifiable feature, or the plurality of optically identifiable features, can be visible to the human eye. The one optically identifiable feature, or the plurality of optically identifiable features, can be invisible to the human eye. The one optically identifiable feature, or the plurality of optically identifiable features, can comprise ribs, protrusions, elevations, studs, spacers, barbs, openings, holes, depressions, grooves and depressions. The one optically identifiable feature, or the plurality of optically identifiable features, can be one or a plurality of images, lines or grooves. The one optically identifiable feature, or the plurality of optically identifiable features, can be flat or one-dimensional. The one optically identifiable feature, or the plurality of optically identifiable features, can be three-dimensional.

The beverage machine can contain one or a plurality of detectors. The one detector, or the plurality of detectors, can be electrically connected (by wire or wirelessly) to a system network. The one detector, or the plurality of detectors, can transmit information pertaining to the use of the single serve capsule in the machine to the system network. The items of information can be collected from one or a plurality of optically identifiable features and/or the machine and then be transmitted to a system network. The items of information collected and transmitted can assist a supplier or manufacturer of the single serve capsule and/or machines, or assist a service technician, to identify issues with the single serve capsule and/or the machine. The items of information collected and transmitted can assist a supplier or manufacturer of the single serve capsules and/or machines in predicting the habits of the consumers, in determining the consumption, in raising orders, in managing the stock, in establishing a customer loyalty program, in collecting data pertaining to consumer preferences, in generating and analyzing data, in predicting production, manufacture and shipping based on the consumption of the consumers. The system network may be located anywhere in the world, including the same state or country as the beverage machine and/or the user, or in a different state or country.

The present teaching provides a method for recycling and/or composting a single serve capsule, the lid, the filter, or a combination thereof. The method can comprise the severing or one or a plurality of elements (if present) from the single serve capsule, the severing of the lid from the single serve capsule, and the composting of one or a plurality of the base elements and/or the lid. The method can comprise a step of composting the entire single serve capsule including the lid, the filter (if present) and/or the base.

Further details, features and advantages of the single serve capsule are derived from the drawings and from the description hereunder of preferred embodiment by means of the drawings. The drawings herein only illustrate exemplary embodiments of the single serve capsule that do not limit the substantial concept of the invention.

### BRIEF DESCRIPTION OF THE DRAWINGS

FIG. 1 shows a schematic sectional view of a single serve capsule according to an exemplary embodiment of the present invention;

FIG. 2 shows a schematic view of the single serve capsule according to a further exemplary embodiment of the present invention;

FIG. 3 shows a schematic detailed view of the ring element according to an exemplary embodiment of the present invention;

FIG. 4 shows a schematic view of the ring element according to a further exemplary embodiment of the present invention;

FIG. 5 shows a schematic detailed view of the ring element according to the exemplary embodiment of the present invention illustrated in FIG. 4;

FIG. 6 shows a further schematic detailed view of the ring element according to the exemplary embodiment of the present invention illustrated in FIG. 4; and

FIG. 7 shows a schematic view of the single serve capsule according to a further exemplary embodiment of the present invention.

FIG. 8 shows a schematic lateral view of a single serve capsule for preparing a beverage.

FIGS. 9A-9B show schematic sectional views of a single serve capsule 10 preparing a beverage.

FIG. 10 shows a schematic view from above of a single serve capsule for preparing a beverage.

FIG. 11 shows a schematic view from above of a single serve capsule for preparing a beverage.

FIG. 12A shows a schematic view a single serve capsule for preparing a beverage.

FIGS. 12B-12C show schematic views from above of a single serve capsule for preparing a beverage.

FIG. 13 shows a schematic sectional view of a single serve capsule for preparing a beverage.

FIGS. 14, 15, 16 show schematic views of single serve capsules for preparing a beverage.

### DETAILED DESCRIPTION

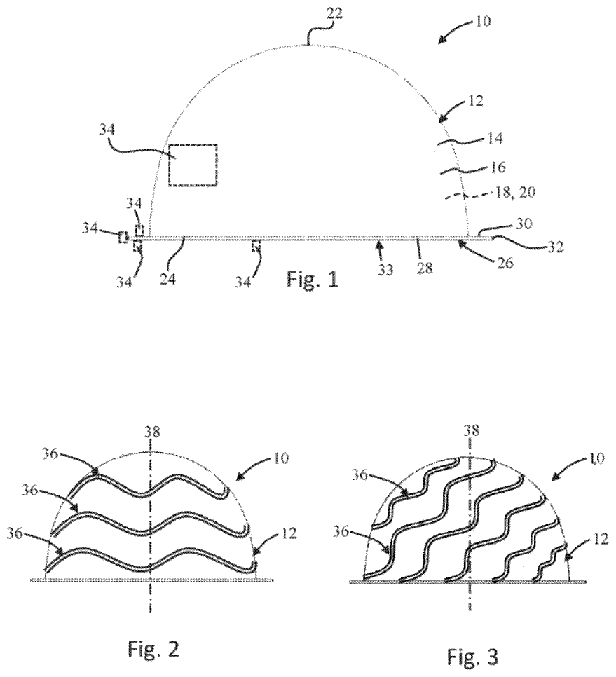

Disclosed in FIG. 1 is a schematic lateral view of a single serve capsule 10 for preparing a beverage.

The single serve capsule 10 has a base element 12 (also referred to as the body). The body, or the base element 12, comprises a lateral wall 14 (also referred to as the capsule wall). The lateral wall 12 extends from a base region 22 (also referred to as the capsule base) to an encircling flange 26 which projects laterally and is in particular configured to be encircling. The base element 12 defines a cavity 20 which is provided for receiving beverage raw material. The base element, on the side facing away from the base region 22, has a filling opening through which the cavity 20 is able to be filled with the beverage raw material.

By way of example, the single serve capsule 10 has a spherically configured base element 12 which on the closed side thereof has the capsule base 22 (which may be configured to be convex and does not at all have to be configured to be planar), and on the open side thereof has an encircling flange 26. Between the capsule base 22 and the flange 26, the capsule wall 14 extends about the cavity 20. The single serve capsule 10 is constructed to be rotationally symmetrical about its centric central longitudinal axis. The flange 26, which is configured to be annular and thus to be encircling in the circumferential direction, projects outward beyond the capsule wall 14 in the radial direction in relation to the centric rotational symmetry axis.

The flange 26 is fixedly connected to a capsule lid 33 (also referred to as the lid) in the form of an in particular annular lid film which closes the cavity 20 on the open side of the base element 12. For this purpose, the flange 26 preferably has a sealing plane which faces the capsule lid 33 and extends approximately perpendicularly to the rotational symmetry axis. The capsule lid 33 in its peripheral region is sealed, welded or adhesively bonded to the flange 26, in particular to the sealing plane.

The capsule lid 33 is preferably embodied from aluminum or plastics material. Configured within the base element 12 is the cavity 20 which is filled with the beverage raw material, for example roasted coffee granules, instant coffee, chocolate powder, tea blend, milk powder and/or the like (not illustrated for reasons of clarity) and is closed by the capsule lid 33.

The spherical design embodiment of the base element 12 is preferably generated by thermoforming, for example deep drawing by negative pressure, positive pressure and/or a movable ram. The base element 12 is preferably configured as a deep-drawn aluminum part. Alternatively, it would also be conceivable for the base element 12 to be configured from plastics material such as polyethylene (PE), polypropylene (PP), polyvinylchloride (PVC) or polyethylene terephthalate (PET). Alternatively, the single serve capsule 10 is produced by means of injection-molding methods, in particular by the single-component, multi-component or in-mold method. As a further alternative, it would be conceivable for the base element 12 to be produced completely or partially from a biologically decomposable material, in particular from cellulose fibers which may be embedded in a resin matrix.

The single serve capsule 12 is provided to be introduced into a brewing unit of a beverage preparation machine 14 in order to prepare a beverage. The brewing unit comprises a first brewing chamber part and a second brewing chamber part, wherein the first or the second brewing chamber part is movable, in particular pivotable or displaceable, relative to the other brewing chamber part, between a converged position in which the first and the second brewing chamber part form a closed brewing chamber, and an open position in which the first and the second brewing chamber part are mutually spaced apart in order for the single serve capsule 1 to be inserted or ejected.

In the closed position, the capsule lid 33 and/or the capsule base 22 are perforated so as to generate perforation openings for incorporating brewing liquid, or for discharging the prepared beverage. The pressurized brewing liquid is directed into the cavity 20. The desired beverage is created as a result of the interaction between the brewing liquid and the beverage raw material, said desired beverage exiting the single serve capsule 12 through the perforation openings and being fed to a beverage vessel. Any potential particles of the beverage raw material can be filtered from the beverage and retained in the single serve capsule 10 by an optional filter medium. However, the capsule lid 33 with multiple perforations preferably functions as a filter element.

The single serve capsule 10 now in particular has a feature 34 which is optically detectable by a detector of the beverage preparation machine. This feature 34 preferably serves for identifying the single serve capsule 10 in the beverage preparation machine. In this way, it can be verified by the beverage preparation machine whether, for example, the single serve capsule 10 located in the brewing chamber is a system-compatible single serve capsule 10 and/or a matching brewing program can be automatically selected and started for the beverage raw material located in the single serve capsule 10. It is also conceivable that brewing parameters which are to be used specifically are embedded in the optically detectable feature 34, and are read by means of the detector.

The optically detectable feature 34 is in particular a machine-readable code, preferably a one-dimensional or multi-dimensional bit code or bar code.

The flange 26 can have an upper face 28 and, opposite thereto, a lower face 30. The upper face 28 can face away from the base element 12. The lower face 30 can face the base element 12.

The flange 26 can have a lateral face 32. The lateral face 32 can extend between the upper face 28 and the lower face 30 and connect said faces 28, 30 to one another.

The lid 33 can be fastened or attached to the base element 12, the lateral wall 14, the flange 26, the upper side 28 of the flange 26, the lateral face 32 of the flange 26, the lower side of the flange 26, or a combination thereof.

The single serve capsule 10 can have one optically detectable feature 34, or a plurality of optically detectable features 34. The one optically detectable feature 34, or the plurality of optically detectable features 34 (schematically illustrated by boxes in dashed lines) can be located on the body or the base element 12, the lateral wall 14, the external face 16, the flange 26, the upper face 28 of the flange 26, the lower face 30 of the flange, the lateral face 34 of the flange 26, the lid 33, or a combination thereof. The one optically detectable feature 34, or the plurality of optically detectable features 34, can be one or a plurality of the optically identifiable features disclosed herein. The one optically detectable feature 34, or the plurality of optically detectable features 34, can be same as the one or the plurality of capsule features 36 disclosed herein. The one optically detectable feature 34, or the plurality of optically detectable features 34, can differ from the one or the plurality of capsule features 36 disclosed herein.

The explanations set forth above in the context of FIG. 1 apply in particular very generally to all variants of the single serve capsule 10 described hereunder, and are in each case not repeated again in the more detailed description of FIGS. 2 to 16 only for reasons of clarity.

Disclosed in FIG. 2 is a schematic lateral view of a single serve capsule 10 for preparing a beverage according to a first variant.

In the first variant, the optically detectable feature 34 extends across the capsule wall 14 of the base element 12. The optically detectable feature 34 comprises a machine-readable code composed of a plurality of lines, wherein all lines, or at least a plurality of lines, extend across the capsule wall 14. It is conceivable that the lines at least in part run parallel to one another and in particular have dissimilar thicknesses.

The lines are printed on the capsule wall 14, or configured as groove-shaped depressions in the capsule wall 14 (or projecting webs on the capsule wall 14).

In the region of the capsule wall 14, the lines are configured to be partially curved and in particular wave-shaped.

The body, or the base element 12, comprises one or a plurality of capsule features 36. The one capsule feature 36, or the plurality of capsule features 36, can be one or a plurality of waves, or have a wave shape. The one capsule feature 36, or the plurality of capsule features 36, can extend so as to be generally horizontal in relation to a central longitudinal axis 38 of the single serve capsule 10.

Disclosed in FIG. 3 is a schematic lateral view of a single serve capsule 10 for preparing a beverage according to a second variant.

The second variant is substantially similar to the first variant, whereby the optically detectable feature 34 extends across the capsule wall 14 as well as across the flange 26. The optically detectable feature 34 is again a machine-readable code which is constructed from a plurality of lines, wherein all lines, or at least a plurality of lines, extend in each case across the capsule wall 14 as well as across the flange 26. It is conceivable that the lines at least in part run parallel to one another and in particular have dissimilar thicknesses.

In the region of the capsule wall 14, the lines are in part curved and in particular configured to be wave-shaped, and in the region of the flange 26 open out into lines which, on a side (lower side 30) of the flange 26 facing away from the capsule lid 33, run straight and in particular radially in relation to the central rotational symmetry axis of the single serve capsule 10.

In this way, the lines in the flange region 26 form in particular a one-dimensional bit code or bar code.

The lines are printed on the capsule wall 14 and/or the flange 26, or are configured as groove-shaped depressions in the capsule wall 14 and/or the flange 26 (or as projecting webs on the capsule wall 14 and/or the flange 26).

The body, or the base element 12, comprises one or a plurality of capsule features 36. The one capsule feature 36, or the plurality of capsule features 36, can be one or a plurality of waves or have a wave shape. The one capsule feature 36, or the plurality of capsule features 36, can extend at an angle (i.e. diagonally) relative to a central longitudinal axis 38 of the single serve capsule 10. Additionally or alternatively, these features can be disposed on the lid 33 and/or the flange 26.

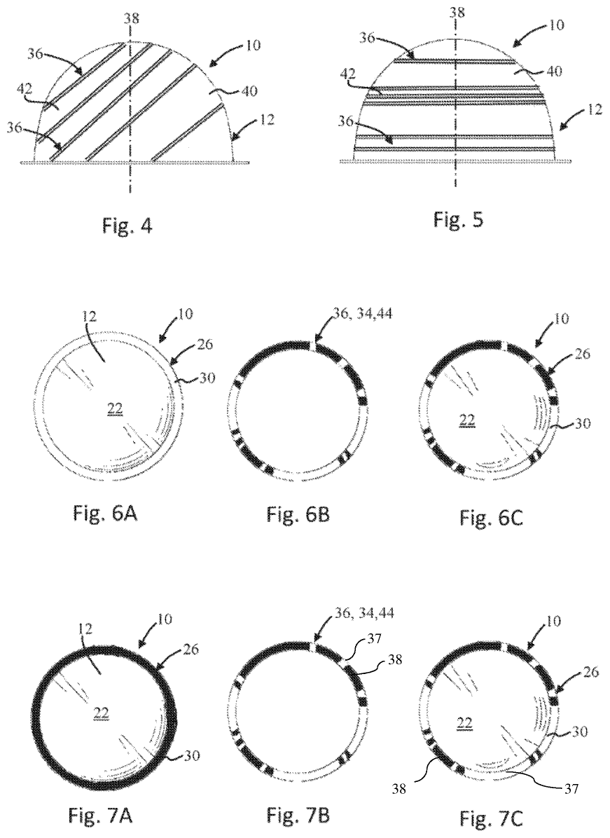

Disclosed in FIG. 4 is a schematic lateral view of a single serve capsule 10 for preparing a beverage according to a third variant.

The third variant is in particular similar to the second variant shown in FIG. 3, the only point of differentiation being that the lines in the region of the capsule wall 14 do not run in a wave shape but straight. The lines run in particular at an angle in relation to the plane of main extent of the capsule lid 33.

The body, or the base element 12, comprises one or a plurality of capsule features 36. The one capsule feature 36, or the plurality of capsule features 36, can run at an angle (i.e. diagonally) relative to a central longitudinal axis 38 of the single serve capsule 10. The spacings between the adjacent capsule features 36 can generally be of identical size. The spacings between the adjacent capsule features 36 can differ. For example, the spacing 40 between specific capsule features 36 can be larger or more pronounced than the spacing 42 between specific other capsule features 36. Additionally or alternatively, these features can be located on the lid 33 and/or the flange 26.

Disclosed in FIG. 5 is a schematic lateral view of a single serve capsule 10 for preparing a beverage according to a fourth variant.

The fourth variant is in particular similar to the first variant shown in FIG. 2, the only point of differentiation being that the lines in the region of the capsule wall 14 do not run in a wave shape but straight. The lines run in particular parallel to the plane of main extent of the capsule lid 33, and thus orthogonally to the central rotational symmetry axis of the single serve capsule 10.

The body, or the base element 12, comprises one or a plurality of capsule features 36. The one capsule feature 36, or the plurality of capsule features 36, can extend at an angle (i.e. horizontally, generally perpendicularly) relative to a central longitudinal axis 38 of the single serve capsule 10. The spacings between the adjacent capsule features 36 can generally be of identical size. The spacings between the adjacent capsule features 36 can differ. For example, the spacing 40 between specific capsule features 36 can be larger or more pronounced than the spacing 42 between specific other capsule features 36. Additionally or alternatively, these features can be located on the lid 33 and/or the flange 26.

Disclosed in FIG. 6C is a schematic view (view onto the side of the single serve capsule 10 facing away from the lid film 33) of a single serve capsule 10 for preparing a beverage according to a fifth variant.

The optically detectable feature 34, 36 is disposed on a separate ring 44 (illustrated in FIG. 6B) which is connected to the base element 12 (illustrated in FIG. 6A). The ring 44 herein is in particular attached to the side (lower side 30) of the flange 26 facing away from the capsule lid 33.

FIG. 6A shows part of the capsule 10, more specifically the base area 30 of the base element. FIG. 6B shows a capsule feature 36 which can contain one or a plurality of optically identifiable features 34. The capsule feature 36 can be a ring 44. The ring 44 can be an O-ring or another element that has the additional function of forming a seal between the single serve capsule 10 and the beverage machine, so as to prevent that water or liquid leaks from between the capsule 10 and the machine. The ring 44 can be composed of the same material as the base, the flange and/or the lid, or from a different material. The ring 44 can have an opening which is sized in such a way that said opening slides over the base area 22 of the body or of the base element 12. However, the opening of the ring 44 can be smaller than the flange 26 in such a way that the ring 44 can be placed against the base area 30 of the flange 26.

As is shown in FIG. 6C, the one optically identifiable feature 34, or the plurality of optically identifiable features 34, of the ring 44 can be seen from a base and/or a side of the capsule 10 or of the flange after the ring 44 has been placed onto the capsule 10. The ring 44 can be fastened (adhesively bonded, adhesively bonded, welded, etc.) to the capsule 10 or the flange 26. Alternatively, the ring 44 can be free of any fastening elements between the ring 44 and the capsule 10 and/or the flange 26.

Disclosed in FIG. 7C is a schematic view (view onto the side of the single serve capsule 10 facing away from the lid film 33) of a single serve capsule 10 for preparing a beverage according to a sixth variant.

The flange 26 is provided with clearances 37 (also referred to as cutouts), which serve for forming the optically detectable features 34, 36. As a result of the clearances 37, webs 38 (or web-type planar protrusions), which project in the radial direction in terms of the central rotational symmetry axis of the single serve capsule 10, are formed in the flange 26.

The clearances 37 extend parallel to the rotational symmetry axis, preferably completely through the flange 26, and are covered by the annular capsule lid 33. The capsule lid 33, on the side thereof facing the flange 26, has in particular a different color than the flange 26 on the side thereof facing away from the capsule lid 33. A view onto the lower side 30 of the flange 26 thus results in a contrasting image of webs and clearances, the capsule lid 33 being visible through the latter. The capsule lid 33, conjointly with the clearances 37, forms a relief-type machine-readable code, preferably a one-dimensional bit code or bar code.

It is alternatively conceivable that the clearances 37 extend parallel to the rotational symmetry axis and not through the entire flange 26 and are only inserted into the side (lower side 30) facing away from the capsule lid 33. The optically detectable feature 34, 36 thus comprises a relief which is incorporated into the lower side 30 and which represents the machine-readable code, preferably a one-dimensional bit code or bar code. The optically detectable feature 34, 36 is therefore configured as a three-dimensional structure in the flange 26. It therefore preferably comprises a plurality of clearances 37 and elevations 38, which are configured in particular in the form of grooves 37 and protrusions 38, which run radially in relation to the centric rotational symmetry axis of the single serve capsule.

It is conceivable that the three-dimensional structure is integrally molded during the production of the base element 12, in particular during a deep drawing process for producing the base element 12. Furthermore, the three-dimensional structure may have been embossed, stamped or engraved in the flange 26. Alternatively, it would be conceivable that the three-dimensional structure is configured in the form of a ladder structure of clearances 37 and non-clearances 38 incorporated in the flange 26.

A further alternative lies in that the optically detectable features 34, 36 in the form of the clearances 37 are not incorporated in the flange 26 of the base element 12, but in a ring 44. The ring is illustrated in FIG. 7B and is connected to the flange 26 of the base element 12 (illustrated in FIG. 7A), for example adhesively bonded to the latter. The ring 44 has a ladder structure of clearances 37 and non-clearances 38 which represent the code, as described above. It is conceivable that the non-clearances 38 are connected to one another in an annular manner only on their radially inward side.

After the ring 44 has been connected to the base element 12, the ring 44 shown in FIG. 7B can be referred to as the second flange region, while the flange 26 which is shown in FIG. 7A and does not have clearances 37 is to be referred to as the first flange region. The first flange region on the side thereof facing the second flange region preferably has a different color than the second flange region on the side thereof facing away from the first flange region.

FIG. 7A shows part of the capsule 10, more specifically the lower side 30 of the base element. The lower side 30 of the flange 26 can have a color (e.g. black, white, blue, red, green, etc.). FIG. 7B shows a capsule feature 36 which can be a ring 44. The ring 44 can have open locations like rungs of a ladder The ring 44 can have a color which differs from the color of the lower side 30 of the flange 26. As can be derived from FIG. 7C, after the ring 44 has been assembled on the capsule 10, the one or a plurality of optically detectable features 34 of the ring 44 interact with the colored base area 30 of the flange so as to generate an optically detectable feature 34 which can be read or identified by a detector.

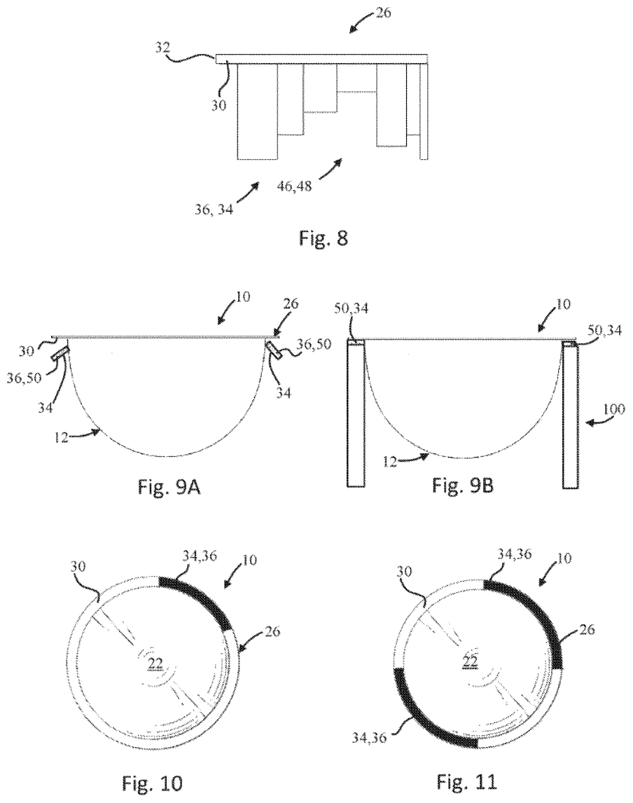

Disclosed in FIG. 8 is a schematic lateral view of a single serve capsule 10 for preparing a beverage according to a seventh variant.

Illustrated in FIG. 8 is a detailed sectional view (section in the radial direction in terms of the central rotational symmetry axis of the single serve capsule 10) of the flange 26. The optically detectable feature 34, 36 is formed by protrusions 46 and depressions 48 which can be incorporated in the flange 26 by deep drawing, stamping, pressing, injection molding or other methods, as described above.

FIG. 8 shows a capsule feature 36 and/or optically identifiable features 34. The features 36, 34 are a series of protrusions 46 and depressions 48, or peaks and troughs, which extend from the base area 30 of the flange 26. The protrusions 46 and depressions 48 can be applied to a ring, as is described above in the context of FIGS. 6A-7C. The protrusions 46 and depressions 48 can be adhesively bonded to the flange 26. The protrusions 46 and clearances 48 can be configured integrally with the flange 26. The optically identifiable features 34, and in particular the protrusions 46 and depressions 48, or peaks and troughs, form an optically identifiable feature 34 which can be read or identified by a detector.

Disclosed in FIG. 9A is a schematic sectional view (section in the radial direction in terms of the central rotational symmetry axis of the singe serve capsule 10) of a single serve capsule 10 for preparing a beverage according to an eighth variant.

The eighth variant is distinguished in that the single serve capsule again has a feature 34 which is in particular optically detectable by a detector of the beverage preparation machine, whereby the single serve capsule 10 however has an encircling lip 50 (also referred to as a wing) which projects from the base element 12, and the optically detectable feature 34 is disposed on the lip 50. The optically detectable feature 34, 36 herein is in particular disposed on a side of the lip 50 facing away from the flange 26.

The lip 50 per se, and/or the connection between the lip 50 and the base element 12, is preferably configured to be flexible or movable in such a manner that the lip 50 (the side of the latter facing the flange 26) can bear on the lower side 30 of the flange 26 in the brewing chamber of the beverage preparation machine (this situation is illustrated in FIG. 9B). The lower side 30 is that side of the flange 26 that faces away from the capsule lid 33.

It is conceivable that the lip 50 is a sealing element which is in particular made of an elastically or plastically deformable material, thus improving the seal between the brewing chamber element and the flange 26.

The lip 50 is in particular configured to be annular, and in particular fastened in an encircling manner to the capsule wall 14. Alternatively, the lip 50 is fastened to the lower side 30 of the flange 26. It would also be conceivable for the lip 50 to be fastened to the radially outward external edge of the flange 26, or to the lower side 30.

Optionally, the lip 50 is fastened to the base element 12 in a transition region from the capsule wall 14 to the flange 26. It is conceivable that the fastening of the lip 50 to the base element 12 functions as a hinge.

In the initial position illustrated in FIG. 9A, the lip 50 is aligned at an angle of 25 to 65 degrees, preferably of 35 to 55 degrees, and particularly preferably of substantially 45 degrees, in relation to a direction of main extent of the flange 26.

The optically detectable feature 34 located on the lip 50 is, for example, a machine-readable code, preferably a one-dimensional or multi-dimensional bit code or bar code.

The single serve capsule 10 is illustrated in FIG. 9A. The single serve capsule 10 comprises one or a plurality of capsule features 36. The capsule feature 36 can be a lip or a wing 50, or a separate element on the body or the base element 12. The lip, or the wing 50, can be attached to the capsule body 12, or be configured integrally with the base element 12. The lip, or the wing 50, can be a ring which fits over the body or the base element. The lip or the wing can extend about the entire circumference of the base element, or only about part of the circumference. The lip, or the wing 50, can be or contain an optically identifiable feature 34, 36. The optically identifiable feature 34, 36 can face the lateral wall 14 or the base area 30 of the base element 12, and face away from the base area 30 of the flange 26. In some configurations however, the optically detectable feature 34, 36 can be additionally or alternatively oriented away from the lateral wall 14 or the base area 30 of the base element 12 and toward the base area 30 of the flange 26. As can be derived from FIG. 9B, the lip, or the wing 50, after the capsule 10 has been inserted into a beverage machine 10, can be deformed, or be folded upward against the flange 26, and be jammed between the flange 26 and the capsule holder of the beverage machine 100. The optically identifiable feature 34, 36 can be read or identified by a detector. The detector can be disposed above, below or laterally beside the capsule.

Disclosed in FIG. 10 is a schematic view from above (view onto the side of the single serve capsule 10 facing away from the lid film 33) of a single serve capsule 10 for preparing a beverage according to a ninth variant.

In the ninth variant, the optically detectable feature 34, 36, thus in particular the machine-readable code, extends only across a sub-segment of the lower side 30 of the circular flange 26, and thus in particular not across the entire circumference of the flange 26.

FIG. 10 shows a single serve capsule 10 which comprises a base element 12 and a flange 26. The base area 30 of the flange 26 contains one or a plurality of capsule features 36 and/or optically identifiable features 34. The one capsule feature 36, or the plurality of capsule features 36, and/or the one optically detectable feature 34, or the plurality of optically detectable features 34, do not extend across the entire circumference of the flange 26 or of the base element 12. Instead, the one capsule feature 36, or the plurality of capsule features 36, and/or the one optically detectable feature 34, or the plurality of optically detectable features 34 are disposed only along a portion of said flange 26 or of said base element 12, e.g. along an arc of 10 degrees or less, an arc of 20 degrees or less, an arc of 30 degrees or less, an arc of 45 degrees or less, an arc of 60 degrees or less, an arc of 90 degrees or less, an arc of 120 degrees or less, an arc of 180 degrees or less, an arc of 270 degrees of less, or an arc of less than 360 degrees.

Disclosed in FIG. 11 is a schematic view from above (view onto the side of the single serve capsule 10 facing away from the lid film 33) of a single serve capsule 10 for preparing a beverage according to a tenth variant.

In a manner similar to the ninth variant, the optically detectable feature 34, 36, thus in particular the machine-readable code, in the tenth variant likewise extends only across a sub-segment of the lower side 30 of the circular flange 26, and thus in particular not across the entire circumference of the flange 26.

FIG. 11 is similar to FIG. 10. The single serve capsule 10 has two discrete portions with capsule features 36 and/or optically identifiable features 34. The region between the capsule features 36 and/or optically detectable features 34 can be free of any capsule features 36 and/or optically detectable features 34. There can be any number of these discrete or partial portions of capsule features 36 and/or optically detectable features 34 (two or more, three or more, four or more, etc.). These sub-portions can be configured directly on the lower side 30 of the flange 26, or be applied to the latter in a subsequent printing or application method, or even be configured as a ring as described above in the context of FIGS. 6B, 7B.

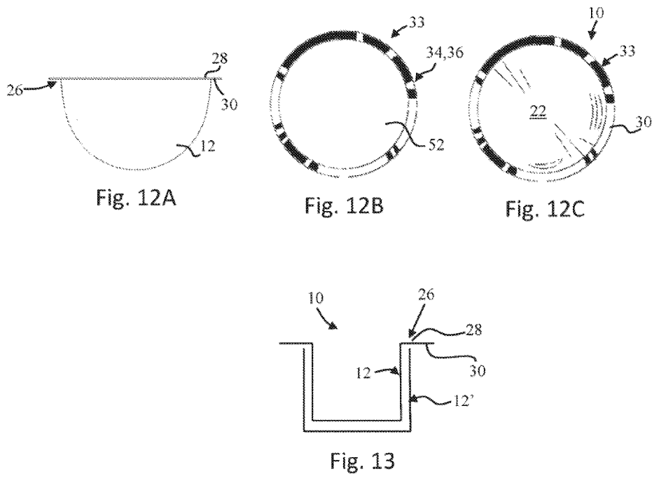

Disclosed in FIG. 12C is a schematic view from above (view onto the lower side (capsule base 22) of the single serve capsule 10 facing away from the lid film 33) of a single serve capsule 10 for preparing a beverage according to an eleventh variant.

The eleventh variant is distinguished in that the flange 26 is at least in part configured to be optically transparent, and the optically detectable feature 34 is disposed in the region of the optically transparent flange 26.

The optically detectable feature 34, 36 is in particular disposed on a side of the flange 26 facing the capsule lid 33, or disposed on a side of the capsule lid 33 facing the flange 26, or disposed on an additional element (in particular a ring 44) disposed between the capsule lid 33 and the flange 33.

In all three cases, the optically detectable feature 34 is detectable through the flange 26 which is configured to be optically transparent. At the same time, the optically detectable feature 34, 36 is protected against external environmental influences. The base element 12 can in particular be configured so as to be almost completely optically transparent.

Alternatively, it would also be conceivable that the base element 12 is constructed in two parts, of a base part and a flange part, wherein only the flange part is configured to be optically transparent, wherein the base part and the flange part are connected to one another.

The capsule lid 33 is depicted in FIG. 12B, wherein the lower side 52 of the capsule lid 33 facing the base element 12 can be seen. In this variant, the optically detectable feature 34, 36 is disposed, preferably imprinted, in the peripheral region of this lower side 52.

The optically detectable feature 34, 36 here comprises a machine-readable code, preferably a one-dimensional or multi-dimensional bit code or bar code.

Illustrated in FIG. 12A is the base element 12 which is either configured to be completely transparent, or only has a transparent flange 26. In order for the transparent base element 12 to be configured, the base element 12 is in particular made of a transparent plastics material, for example a transparent film.

FIG. 12A shows a body, or a base element 12, and a flange 26 of the single serve capsule. The base element 12 and/or the flange 26 can be at least partially transparent, light-permeable, see-through, or a combination thereof. A lid 33 is illustrated in FIG. 12B. The lid comprises an upper side and, opposite thereto, a lower side 52. The lid 33, and in particular the lower side 52 of the lid 33, have one or a plurality of capsule features 36 and/or optically identifiable features 34. FIG. 12B shows the assembled single serve capsule 10 with a view onto the lower side of the body, or of the base element 12. The lower side 52 of the lid 33 is disposed in such a way that said lower side 52 faces the upper side 28 of the flange 26 in such a way that, when viewing the single serve capsule 10 from below, the one capsule feature 36, or the plurality of capsule features 36, and/or the one optically detectable feature 34, or the plurality of optically detectable features 34, are visible through the at least partially transparent, translucent or see-through flange 26, or the lower side 30 of the flange 26. Accordingly, the one capsule feature 36, or the plurality of capsule features 36, and/or the one optically detectable feature 34, or the plurality of optically detectable features 34 would be protected against liquid splashes and/or against damage during production, shipping and/or handling.

Disclosed in FIG. 13 is a schematic sectional view of a single serve capsule 10 for preparing a beverage according to a twelfth variant.

In comparison to the other variants, the twelfth variant is distinguished in particular in that the single serve capsule 12 has a further base element 12′ (also referred to as the outer base element 12′) which at least partially surrounds the base element 12 (also referred to as the inner base element 12). The further base element 12′ here in particular has a further cavity 20′ in which the base element 12 is partially disposed. The base element (12) here is preferably disposed so far within the further cavity 20′ in such a manner that a further capsule wall 14′ of the further base element 12′ extends, in particular parallel to the capsule wall 14 of the base element 12, to the flange (26).

The further base element 12′ is preferably configured to be free of a flange so that the flange 26 of the inner base element 12 is not covered and, in this way, the optically detectable feature 34, 36 disposed on the lower side 30 of the flange 26 is readable and the field of view is not obscured.

The further base element 12′ can advantageously be configured as a shape-imparting or structure-imparting base part, while only the inner base element 12, which has the flange 26 with the optically detectable feature 34, 36, can be optimized with a view to a favorable production method.

The material in the region of the capsule wall 14 of the inner base element 12 is preferably configured to be softer, less stiff, or thinner than in the region of the capsule wall 14′ of the outer base element 12′.

It is also conceivable that the material of the inner base element 12 is configured to be more impermeable to gas than the material of the outer base element 12′.

The inner base element 12 and the outer base element 12′ are preferably adhesively bonded, compressed or welded to one another in a planar manner in the region of the capsule walls 14.

The inner base element 12 and the outer base element 12′ can be made of the same material or of different materials.

A single serve capsule 10 is illustrated in FIG. 13. The single serve capsule 10 has a body, or a base element 12, and an outer body or base element 12′. The outer body, or the base element 12′, can be substantially identical to the body or the base element 12, so that all remarks pertaining to the base element 12 also apply to the outer base element 12′. The base element 12 is sized in such a way that it fits into the outer base element 12′. The base element 12 has a flange 26, and the outer base element 12′ is free of a flange. The two base elements 12, 12′ can be connected to one another by an interference fit or by a fastening means or a fastening method (welding, adhesive bonding, etc.). Each of the surfaces of the base element 12 and/or of the base element 12′ can have one or a plurality of the capsule features 36 and/or optically identifiable features 34 disclosed herein.

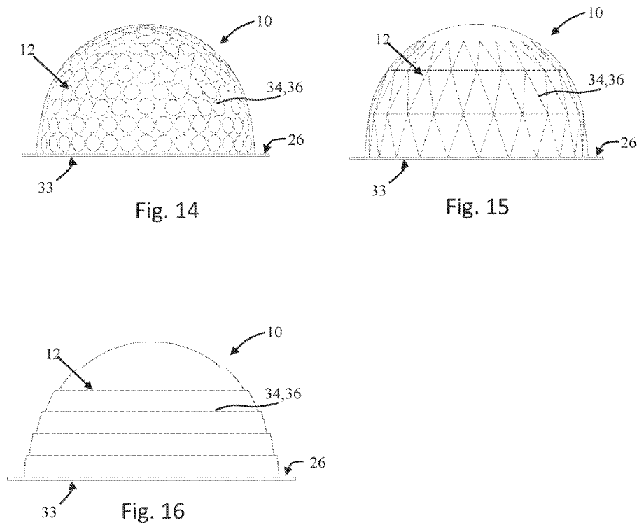

Disclosed in FIGS. 14, 15 and 16 are schematic lateral views of single serve capsules 10 for preparing a beverage according to a thirteenth, fourteenth and fifteenth variant.

In these three variants, the optically detectable features 34, 36 are configured in the form of three-dimensional structurings of the capsule wall 14. In the thirteenth variant, the structuring comprises spherical shapes, in the fourteenth variant lozenge shapes, and in the fifteenth variant encircling protrusions.

Illustrated in FIGS. 14, 15 and 16 is a single serve capsule 10. The single serve capsule 10 comprises a body, or a base element 12, a flange 26 and a lid 33. The body, or the base element 12, the lateral wall 14 (internal and/or external faces), the flange 26, the lid 33, or a combination thereof, have one or a plurality of capsule features 36 and/or optically identifiable features 34. The one capsule feature 36, or the plurality of capsule features 36, and/or the one optically detectable feature 34, or the plurality of optically detectable features 34, in FIG. 14 can be dimples, elevations, depressions or notches. The one capsule feature 36, or the plurality of capsule features 36, and/or the one optically identifiable feature 34, or the plurality of optically identifiable features 34, may be similar to the dimples of a golf ball. The one capsule feature 36, or the plurality of capsule features 36, and/or the one optically detectable feature 34, or the plurality of optically detectable features 34 in FIG. 15 can be composed of a multiplicity of lozenges, lozenges, triangular or square flat faces. The one capsule feature 36, or the plurality of capsule features 36, and/or the one optically identifiable feature 34, or the plurality of optically identifiable features 34, in FIG. 16 can be one or a plurality of grooves, steps, ribs or rings. The one capsule feature 36, or the plurality of capsule features 36 and/or the one optically identifiable feature 34, or the plurality of optically identifiable features 34, in FIG. 16 can be one or a plurality of spirals, arcs or curved features.

1. A single serve capsule for preparing a beverage with the aid of a beverage preparation machine, the single serve capsule having a base element with a cavity for receiving a beverage raw material, and a capsule lid which closes the cavity the base element comprising a capsule base, an encircling flange and a capsule wall which extends from the capsule base to the encircling flange; the capsule lid being fastened to the encircling flange; the single serve capsule having an optically detectable feature which is optically detectable by a detector of the beverage preparation machine and which is disposed on a side of the encircling flange facing away from the capsule lid, wherein the single serve capsule has a further base element which at least partially surrounds the base element

2. The single serve capsule as claimed in claim 1, wherein the further base element comprises a further cavity in which the base element is partially disposed.

3. The single serve capsule as claimed in claim 2, wherein the base element is disposed so far within the further cavity that a further capsule wall of the further base element extends parallel to the capsule wall of the base element, to the flange.

4. The single serve capsule as claimed in claim 1, wherein the further base element is free of a flange.

5. The single serve capsule as claimed in claim 1, wherein material in a region of the capsule wall of the base element is configured to be softer, less stiff, or thinner than in a region of the capsule wall of the further base element.

6. The single serve capsule as claimed in claim 1, wherein material of the base element is configured to be more impermeable to gas than a material of the further base element.

7. The single serve capsule as claimed in claim 1, wherein the base element and the further base element are adhesively bonded or welded to one another in a planar manner in a region of the capsule walls.

8. The single serve capsule as claimed in claim 1, wherein, the base element and the further base element are made of the same material or of different materials.

9. The single serve capsule as claimed in claim 1, wherein, the optically detectable feature comprises being a machine-readable code, a one-dimensional or multi-dimensional bit code or bar code.

10. Use of the single serve capsule as claimed in claim 1 for preparing the beverage with the aid of the beverage preparation machine.
